(19) United States
(12) Patent Application Publication
(10) Pub. No.: US 2026/0088681 A1
(43) Pub. Date: Mar. 26, 2026

(54) STATOR AND ROTATING ELECTRIC MACHINE

(71) Applicant: MITSUBISHI GENERATOR CO., LTD., Kobe City, Hyogo (JP)

(72) Inventor: Kazuaki OGURA, Chiyoda-ku, Tokyo (JP)

(73) Assignee: Mitsubishi Generator Co., Ltd., Kobe City, Hyogo (JP)

(21) Appl. No.: 19/120,918

(22) PCT Filed: Jan. 17, 2023
(86) PCT No.: PCT/JP2023/001134

§ 371 Date: Apr. 14, 2025

(51) Int. Cl. H02K 5/24

(52) U.S. Cl. CPC H02K 5/24

(57) ABSTRACT

A stator includes: a stator core; stator coils wound at the stator core; and a plurality of support members inserted between the stator coils adjacent to each other so as to retain the stator coils, at a coil end where the stator coils protrude, such that a total contact surface area of the support members with the stator coils is larger in a coil end distal portion away from the stator core than in a coil end base portion close to the stator core. A rotating electric machine includes: a rotor; and the above stator provided around the rotor.

### TECHNICAL FIELD

The present disclosure relates to a stator and a rotating electric machine.

### BACKGROUND ART

A rotating electric machine is composed of a rotor and a stator, and converts change in a magnetic field generated through rotation of the rotor to electric energy by the stator. The stator includes a stator core and coil ends which are both ends of coils wound at the stator core and protrude from the stator core. Due to a magnetic field generated during operation of the rotating electric machine, an electromagnetic force having a frequency that is two times the operation frequency acts on the stator, thus causing vibration.

In order to suppress the vibration, it is proposed that an adhesion adjustment member and an insulation member are provided between stator coils at coil ends. For example, in Patent Document 1, tapes having predetermined surface adhesiveness are used as adhesion adjustment members, and the tapes are interposed between an insulation member provided between a plurality of stator coils, and the stator coils opposed to each other, whereby the natural frequency is adjusted to be smaller than the excitation frequency based on an electromagnetic force, thus preventing resonance based on the electromagnetic force.

### CITATION LIST

### Patent Document

Patent Document 1: Japanese Laid-Open Patent Publication No. 2007-110771

### SUMMARY OF THE INVENTION

### Problem to be Solved by the Invention

However, during operation of the rotating electric machine, the temperature increases due to Joule heat based on the electromotive force, an interlinking magnetic flux, and the like, and thus, in the conventional rotating electric machine, the adhesion adjustment members and the insulation member between the stator coils hamper cooling.

The present disclosure has been made to solve the above problem, and an object of the present disclosure is to provide a rotating electric machine in which vibration occurring during operation of the rotating electric machine can be suppressed and temperature increase at coil ends can be suppressed.

### Means to Solve the Problem

A stator according to the present disclosure includes: a stator core; stator coils wound at the stator core; and a plurality of support members inserted between the stator coils adjacent to each other so as to retain the stator coils, at a coil end where the stator coils protrude, such that a total contact surface area of the support members with the stator coils is larger in a coil end distal portion away from the stator core than in a coil end base portion close to the stator core.

### Effect of the Invention

According to the present disclosure, it is possible to suppress vibration at coil ends, and also to increase the volume of cooling air flowing to the coil end base portion where the coil temperature is high, and suppress increase in the coil temperature in the coil end base portion.

### BRIEF DESCRIPTION OF THE DRAWINGS

FIG. 1 is a plan view showing a conceptual configuration of a rotating electric machine according to embodiment 1.

FIG. 2 is a side view showing an end of a stator of the rotating electric machine according to embodiment 1.

FIG. 3 is a view as seen from the direction of arrow A in FIG. 2 according to embodiment 1.

FIG. 4 is a graph showing the relationship between a coil end axial-direction position and a coil temperature according to embodiment 1.

FIG. 5 is a view as seen from the direction of arrow A in FIG. 2 according to embodiment 2.

FIG. 6 is a view as seen from the direction of arrow A in FIG. 2 according to embodiment 3.

### DESCRIPTION OF EMBODIMENTS

### Embodiment 1

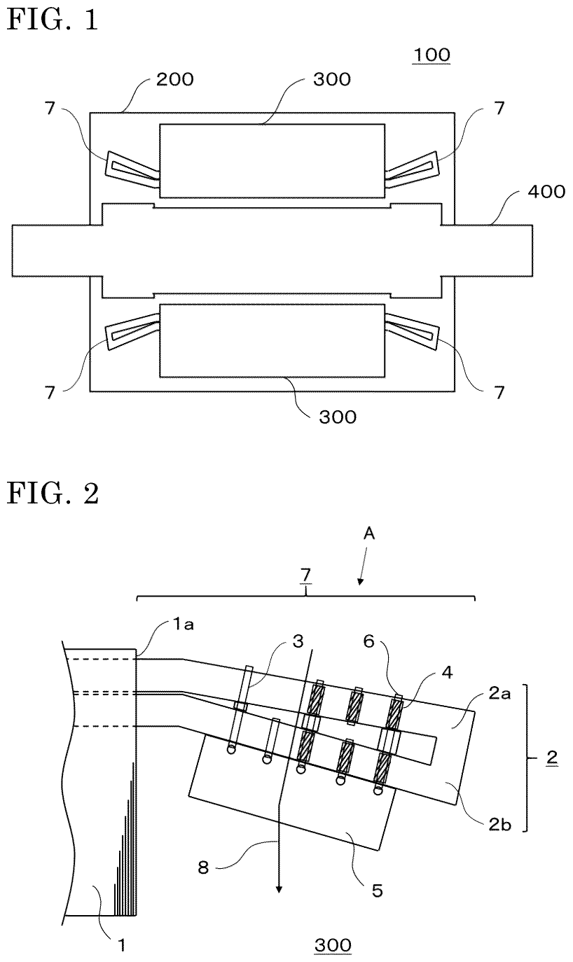

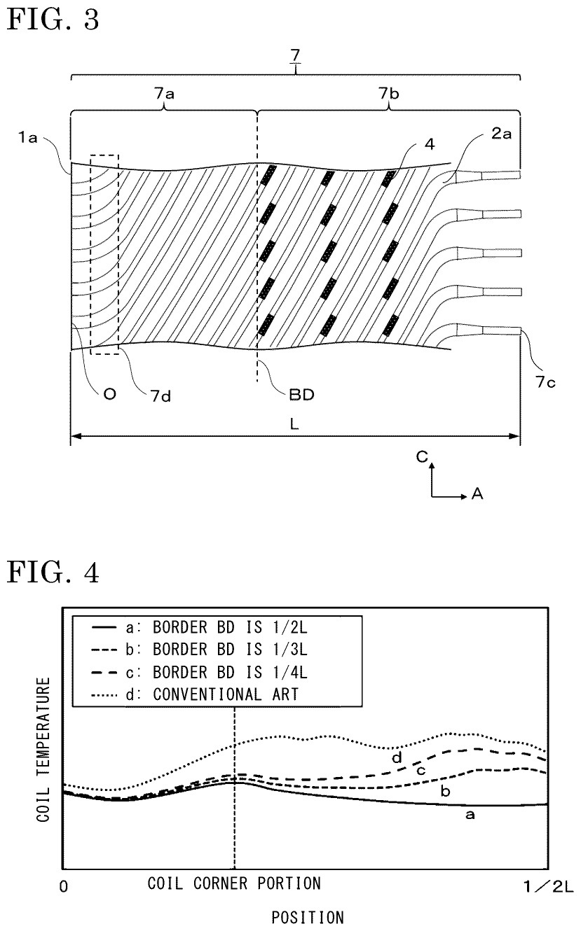

A rotating electric machine according to embodiment 1 will be described with reference to FIG. 1, FIG. 2, and FIG. 3. As shown in FIG. 1, a rotating electric machine 100 includes a stator 300 supported and fixed to a frame 200, and a rotor 400 rotatably supported, and converts change in a magnetic field generated through rotation of the rotor 400 to electric energy by the stator 300. FIG. 2 is a side view showing an end of the stator 300 of the rotating electric machine according to embodiment 1. The stator 300 of the rotating electric machine includes a stator core 1 formed by stacking magnetic sheets, and stator coils 2 wound at the stator core 1. The stator coils 2 include a plurality of upper stator coils 2a and a plurality of lower stator coils 2b, and ends of the upper and lower stator coils 2a and 2b protrude from an end 1a of the stator core 1 and are electrically connected to each other, thus forming a coil end 7. A plurality of insulation rings 3 are inserted between the upper and lower stator coils 2a and 2b, thereby retaining the coil end 7 in a loop shape. The outer circumferential side of the lower stator coil 2b is supported by a coil end fixation plate 5.

The plurality of upper and lower stator coils 2a and 2b are adjacent to each other with gaps therebetween, and support members 4 are inserted between the adjacent upper stator coils 2a and between the adjacent lower stator coils 2b. The support members 4 keep the gaps between the adjacent upper stator coils 2a and between the adjacent lower stator coils 2b constant and ensure rigidity thereof. The dimensions and the shapes of the support members 4 are such a rectangular parallelepiped that the thickness is about 1 cm and contact surfaces with the upper or lower stator coils 2a or 2b have a rectangular shape of about 4 square cm, in a case where the gaps between the adjacent upper stator coils 2a and between the adjacent lower stator coils 2b are about 1 cm, for example. Here, the contact surface dimensions of the support members 4 are the same dimensions, irrespective of their provided positions.

The number of the support members 4 to be provided and the contact surface dimensions thereof influence the natural frequency of the coil end 7. By increasing the number of the support members 4 to be provided or the contact surface dimensions thereof, the natural frequency of the coil end 7 is increased. That is, the number of the support members 4 to be provided or the contact surface dimensions thereof are determined so that the natural frequency of the coil end 7 becomes greater than the excitation frequency based on an electromagnetic force.

The coil end fixation plate 5, the upper and lower stator coils 2a and 2b, the insulation rings 3, and the support members 4 are bound to each other by insulation tapes 6, whereby the coil end 7 is fixed integrally.

The coil end 7 is cooled from the outer side by cooling air 8 flowing through gaps among the upper and lower stator coils 2a and 2b, the insulation rings 3, the support members 4, and the coil end fixation plate 5 from the radially inner side to the radially outer side of the stator 300.

FIG. 3 is a view as seen from the direction of arrow A in FIG. 2. A coordinate system is shown at the lower right in the drawing, a C direction represents the circumferential direction, and an A direction represents the axial direction. With the end la (the base of the coil) of the stator core 1 defined as a start point O and a tip 7c of the coil end 7 defined as an end point, a length L is defined in the axial direction (which is not a direction along the coil end 7). A side close to the start point O is defined as a coil end base portion 7a, a side close to the tip away from the base of the coil is defined as a coil end distal portion 7b, and the boundary between the coil end base portion 7a and the coil end distal portion 7b is defined as a border BD. The support members 4 are not provided in the coil end base portion 7a and are provided in the coil end distal portion 7b.

FIG. 4 shows comparison of temperature distributions in a position range of 0 to ½ L where the coil temperature is particularly high, with respect to a conventional coil end (d in FIG. 4) and conditions where the border BD is ½ L (a in FIGS. 4), ⅓ L (b in FIG. 4), and ¼ L (c in FIG. 4), for example. The horizontal axis indicates a distance from the start point O, and the vertical axis indicates the internal temperature of the upper stator coil 2a forming the coil end 7. Because of a high magnetic flux density and less cooling due to thick coil insulation at a coil corner portion 7d (shown in FIG. 3) where the upper and lower stator coils 2a and 2b have a curved shape, the temperature becomes high. As other parts, at positions where the support members 4 are provided, flow of cooling air is obstructed, so that the temperature becomes high. On the other hand, in the cases where the border BD is ½ L, ⅓ L, and ¼ L (a to c in FIG. 4), the coil temperature slightly increases at the coil corner portion 7d but the increase width can be significantly reduced as compared to the conventional coil end (d in FIG. 4). This is because, at the part where the support members 4 are not provided, cooling air flows more and thus cooling is performed intensively. In particular, in the case where the border BD is ½ L (a in FIG. 4), the coil temperature can be greatly decreased from the position of the coil corner portion 7d as a boundary, and thus a high cooling effect is exhibited.

As described above, heat generated due to a high magnetic flux density concentrates particularly on the coil corner portion 7d. Therefore, in order that the coil corner portion 7d is present in a range where the support members 4 are absent, the border BD may be located in a range of ¼ L or greater and smaller than 1 L from the start point O, and is preferably located in a range of ⅓ L or greater and smaller than 1 L. When the border BD is located at about ½ L, the cooling effect can be further enhanced. The support members 4 are provided at appropriate positions from the standpoint of suppressing vibration. Specifically, the positions may be determined so that the natural frequency becomes greater than the excitation frequency based on the electromagnetic force as described above.

As described above, the support members 4 are not provided in the coil end base portion 7a and are provided in the coil end distal portion 7b, whereby the air flow resistance is reduced in the coil end base portion 7a where a magnetic flux density is high and the temperature readily increases as compared to the coil end distal portion 7b, so that cooling air flows more in the coil end base portion 7a. Thus, increase in the stator coil temperature in the coil end base portion 7a can be suppressed. Further, the coil end base portion 7a whose temperature readily increases can be cooled intensively, whereby the axial-direction temperature distribution in the coil end 7 can be uniformed.

### Embodiment 2

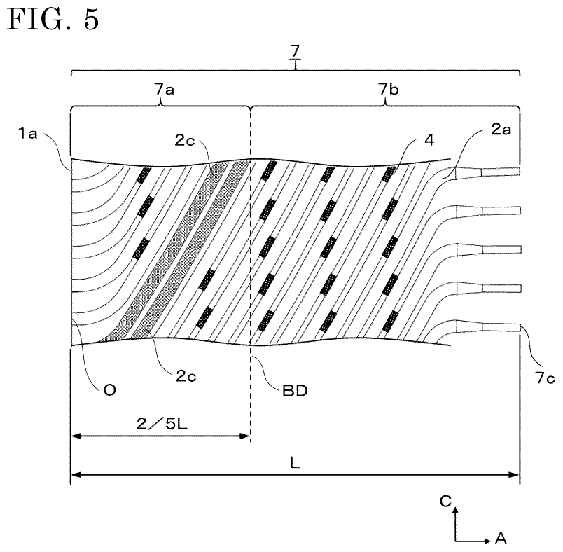

FIG. 5 is a view as seen from the direction of arrow A in FIG. 2. A coordinate system is shown at the lower right in the drawing, a C direction represents the circumferential direction, and an A direction represents the axial direction. In embodiment 1, the example in which the support members 4 are not provided in the coil end base portion 7a has been shown, whereas in embodiment 2, an example in which a smaller number of support members 4 than in the coil end distal portion 7b are provided also in the coil end base portion 7a, is shown. The same configurations as in embodiment 1 will not be described repeatedly. In FIG. 5, the same reference characters as in FIG. 3 denote the same or corresponding parts.

As in embodiment 1, the dimensions and the shapes of the support members 4 are such a rectangular parallelepiped that has a thickness approximately equal to the gaps between the adjacent upper and lower stator coils 2a and 2b and has contact surfaces with the upper and lower stator coils 2a and 2b. The contact surface dimensions of the support members 4 are the same dimensions, irrespective of their provided positions.

At the coil end 7 shown in FIG. 5, the border BD is ⅖ L, for example. The number of the support members 4 provided in the coil end base portion 7a is smaller than the number of the support members 4 provided in the coil end distal portion 7b. It is effective that the support members 4 provided in the coil end base portion 7a are not provided at the gaps between the upper and lower stator coils 2a and 2b where the temperature becomes relatively high among axial-direction positions due to difference in the magnetic flux density in the circumferential direction based on difference among phases of currents flowing through the upper and lower stator coils 2a and 2b, and the support members 4 are provided at other gaps, for example. For example, in a case where the stator 300 has seventy-two of each of the upper and lower stator coils 2a and 2b, two of the upper and lower stator coils 2a and 2b have a high temperature at intervals of 60 degrees on the circumference of the coil end 7. Therefore, in the coil end base portion 7a shown in FIG. 5, the support members 4 are not provided at three gaps adjacent to the two upper stator coils 2c having a high temperature. Further, such parts where the support members 4 are not provided are set at six locations at intervals of 60 degrees, and thus eighteen (¼) support members 4 are removed in the circumferential direction. The same applies to the support members 4 provided between the lower stator coil 2b. That is, the ratio of the numbers of the support members 4 provided at axial-direction positions respectively in the coil end base portion 7a and the coil end distal portion 7b is 3:4.

Here, the example in which the border BD is ⅖ L has been shown, but the border BD may be determined in the same manner as in embodiment 1. The ratio of the numbers of the support member 4 provided at axial-direction positions respectively in the coil end base portion 7a and the coil end distal portion 7b may be, for example, 1:5 to 3:4, and is preferably 1:4. The support members 4 are provided at appropriate positions from the standpoint of suppressing vibration. Specifically, the positions may be determined so that the natural frequency becomes greater than the excitation frequency based on the electromagnetic force.

As described above, the number of the support members 4 provided in the coil end base portion 7a is smaller than the number of the support members 4 provided in the coil end distal portion 7b, whereby the air flow resistance in the coil end base portion 7a is reduced, so that cooling air flows more. Thus, increase in the stator coil temperature in the coil end base portion 7a can be suppressed. In addition, the upper and lower stator coils 2a and 2b where the temperature readily increases in the coil end base portion 7a can be intensively cooled, whereby the axial-direction temperature distribution in the coil end 7 can be uniformed.

Further, in the coil end base portion 7a, the support members 4 are not provided at the gaps between the upper and lower stator coils 2a and 2b where the temperature becomes relatively high as compared to the surroundings, and the support members 4 are provided at other gaps, whereby the upper and lower stator coils 2a and 2b where the temperature is high can be intensively cooled. Thus, it is possible to uniform not only the axial-direction temperature distribution in the coil end 7 but also the circumferential-direction temperature distribution in the coil end base portion 7a.

In embodiment 1 and embodiment 2, the examples in which all of the dimensions and the shapes of the support members 4 are the same have been shown, but some of the support members 4 may have different dimensions and shapes.

### Embodiment 3

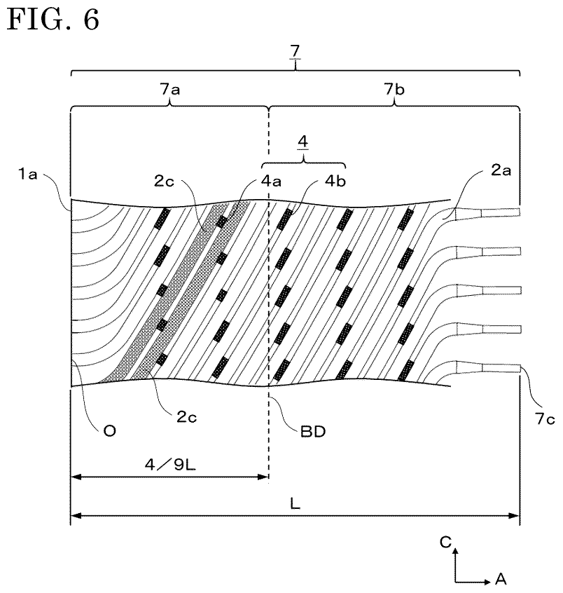

FIG. 6 is a view as seen from the direction of arrow A in FIG. 2. A coordinate system is shown at the lower right in the drawing, a C direction represents the circumferential direction, and an A direction represents the axial direction. In embodiment 1 and embodiment 2, the examples in which the number of the support members 4 provided at the coil end 7 is changed have been shown, whereas in embodiment 3, an example in which the contact surface dimensions of the support members 4 are changed is shown. The same configurations as in embodiment 1 and embodiment 2 will not be described repeatedly. In FIG. 6, the same reference characters as in FIG. 3 denote the same or corresponding parts.

Among the support members 4, support members 4a provided at certain parts of the coil end base portion 7a have smaller contact surface dimensions than other support members 4b. For example, of the contact surface dimensions of the support members 4a, the radial-direction length is 4 cm and the axial-direction length is 2 cm. The contact surface dimensions of the support members 4b are the same as those of the support members 4 in embodiment 1. The support members 4a and the support members 4b are for keeping the gaps between the adjacent upper or lower stator coils 2a, 2b constant, and therefore have the same thickness as in embodiment 1 and embodiment 2.

At the coil end 7 shown in FIG. 6, the border BD is 4/9 L, for example. The contact surface dimensions of the support members 4a provided at certain parts of the coil end base portion 7a are smaller than the contact surface dimensions of the support members 4 shown in embodiment 1 and embodiment 2. It is effective that the support members 4a are provided between the upper and lower stator coils 2a and 2b where the temperature becomes relatively high among axial-direction positions due to difference in the magnetic flux density in the circumferential direction based on difference among phases of currents flowing through the upper and lower stator coils 2a and 2b, for example. As described in embodiment 2, for example, in a case where the stator 300 has seventy-two of each of the upper and lower stator coils 2a and 2b, two of the upper and lower stator coils 2a and 2b have a high temperature at intervals of 60 degrees on the circumference of the coil end 7. Therefore, in the coil end base portion 7a shown in FIG. 6, the support members 4a having smaller contact surface dimensions are provided at three gaps adjacent to the two upper stator coils 2c where the temperature becomes high. Further, the parts where the support members 4a are provided as described above are set at six locations at intervals of 60 degrees, and thus eighteen support members 4a are provided in the circumferential direction. The same applies to the support members 4a provided between the lower stator coils 2b.

Here, the example in which the border BD is 4/9 L has been shown, but the border BD may be determined in the same manner as in embodiment 1. For example, the ratio of the contact surface dimensions of the support members 4 in the coil end base portion 7a and the coil end distal portion 7b may be 1:4 to 2:3, and is preferably 1:2. The support members 4a and 4b are provided at appropriate positions and with appropriate dimensions from the standpoint of suppressing vibration. Specifically, the positions and the contact surface dimensions may be determined so that the natural frequency becomes greater than the excitation frequency based on the electromagnetic force.

As described above, the contact surface dimensions, with the stator coils 2, of at least one of the support members 4 provided in the coil end base portion 7a are smaller than the contact surface dimensions, with the stator coils 2, of the support members 4 provided in the coil end distal portion 7b, whereby the air flow resistance in the coil end base portion 7a is reduced, so that cooling air flows more. Thus, increase in the stator coil temperature in the coil end base portion 7a can be suppressed. In addition, the upper and lower stator coils 2a and 2b where the temperature readily increases in the coil end base portion 7a can be intensively cooled, whereby the axial-direction temperature distribution in the coil end 7 can be uniformed. Further, in the coil end base portion 7a, the support members 4a having smaller contact surface dimensions than the support members 4 in embodiment 1 and embodiment 2 are provided between the upper and lower stator coils 2a and 2b where the temperature becomes relatively high as compared to the surroundings, whereby the upper and lower stator coils 2a and 2b where the temperature is high can be intensively cooled. Thus, it is possible to uniform not only the axial-direction temperature distribution in the coil end 7 but also the circumferential-direction temperature distribution in the coil end base portion 7a.

In the present embodiment, the example in which the support members 4a having smaller contact surface dimensions than the support members 4 are provided at certain parts in the coil end base portion 7a, has been shown. However, the support members 4a may be provided also in the coil end distal portion 7b. In addition, in embodiment 3, all the support members provided in the coil end base portion 7a may be the support members 4a having smaller contact surface dimensions than the support members 4.

Without limitation to the above, the embodiments may be freely combined, any component in each embodiment may be modified, or any component in each embodiment may be omitted.

### DESCRIPTION OF THE REFERENCE CHARACTERS

100 rotating electric machine
200 frame
300 stator
400 rotor
1 stator core
2 stator coil
2a upper stator coil
2b lower stator coil
3 insulation ring
4, 4a, 4b support member
5 coil end fixation plate
6 insulation tape
7 coil end
7a coil end base portion
7b coil end distal portion
8 cooling air

1. A stator comprising:
a stator core;
stator coils wound at the stator core; and
a plurality of support members inserted between the stator coils adjacent to each other so as to retain the stator coils, at a coil end where the stator coils protrude, such that a total contact surface area of the support members with the stator coils is larger in a coil end distal portion away from the stator core than in a coil end base portion close to the stator core.

2. The stator according to claim 1, wherein
the plurality of support members are not provided in the coil end base portion and are provided in the coil end distal portion.

3. The stator according to claim 1, wherein
a number of the support members provided in the coil end base portion is smaller than a number of the support members provided in the coil end distal portion.

4. The stator according to claim 1, wherein
contact surface dimensions, with the stator coils, of at least one of the support members provided in the coil end base portion are smaller than contact surface dimensions, with the stator coils, of the support members provided in the coil end distal portion.

5. The stator according claim 1, wherein
a border between the coil end base portion and the coil end distal portion is at a position in a range of ¼ L or greater and smaller than 1 L, where L is an axial-direction length with an end of the stator core defined as a start point and a tip of the coil end defined as an end point.

6. A rotating electric machine comprising:
a rotor; and
the stator according to claim 1, which is provided around the rotor.

7. The stator according to claim 2, wherein
a border between the coil end base portion and the coil end distal portion is at a position in a range of ¼ L or greater and smaller than 1 L, where L is an axial-direction length with an end of the stator core defined as a start point and a tip of the coil end defined as an end point.

8. The stator according to claim 3, wherein
a border between the coil end base portion and the coil end distal portion is at a position in a range of ¼ L or greater and smaller than 1 L, where L is an axial-direction length with an end of the stator core defined as a start point and a tip of the coil end defined as an end point.

9. The stator according to claim 4, wherein
a border between the coil end base portion and the coil end distal portion is at a position in a range of ¼ L or greater and smaller than 1 L, where L is an axial-direction length with an end of the stator core defined as a start point and a tip of the coil end defined as an end point.

10. A rotating electric machine comprising:
a rotor; and
the stator according to claim 2, which is provided around the rotor.

11. A rotating electric machine comprising:
a rotor; and
the stator according to claim 3, which is provided around the rotor.

12. A rotating electric machine comprising:
a rotor; and
the stator according to claim 4, which is provided around the rotor.

13. A rotating electric machine comprising:
a rotor; and
the stator according to claim 5, which is provided around the rotor.

14. A rotating electric machine comprising:
a rotor; and
the stator according to claim 7, which is provided around the rotor.

15. A rotating electric machine comprising:
a rotor; and
the stator according to claim 8, which is provided around the rotor.

16. A rotating electric machine comprising:
a rotor; and
the stator according to claim 9, which is provided around the rotor.
